(19) United States
(12) Patent Application Publication
(10) Pub. No.: US 2022/0247186 A1
(43) Pub. Date: Aug. 4, 2022

(54) APPARATUS, SYSTEM AND METHOD FOR CHARGING

(71) Applicant: Autel Robotics Co., Ltd., Shenzhen (CN)

(72) Inventor: Wei QIN, Shenzhen (CN)

(21) Appl. No.: 17/660,445

(22) Filed: Apr. 25, 2022

Related U.S. Application Data
(63) Continuation of application No. PCT/CN2020/123309, filed on Oct. 23, 2020.

(30) Foreign Application Priority Data
Oct. 25, 2019 (CN) 201911025795.0

(51) Int. Cl. H02J 7/00

(52) U.S. Cl. CPC H02J 7/0014; H02J 7/007192; H02J 7/00036

(57) ABSTRACT

The embodiments are a charging apparatus, a charging system and a charging method. The charging apparatus is configured to charge a data communication battery. The charging apparatus includes a charging power supply and a balancing apparatus. the charging power supply is electrically connected to the data communication battery, the balancing apparatus is electrically connected to the data communication battery, and the balancing apparatus is configured to obtain first information of the data communication battery to implement voltage balancing among the batteries in the data communication battery according to the first information; and the charging power supply is configured to obtain second information of the data communication battery to output a voltage or current according to the second information to charge the data communication battery.

### CROSS-REFERENCE TO RELATED APPLICATIONS

The present application is a continuation of International Application No. PCT/CN2020/123309, filed on Oct. 23, 2020, which claims priority to Chinese patent application No. 201911025795.0, filed on Oct. 25, 2019, which is incorporated herein by reference in its entirety.

### TECHNICAL FIELD

The present invention relates to the field of battery charging, and in particular, to a charging apparatus, a charging system and a charging method.

### BACKGROUND

Rechargeable batteries have been widely applied in all walks of life currently. In different application fields, batteries may have different charging voltages and charging currents. During the manufacturing of the same series of products, different models of products may also have different charging voltages and charging currents. If one charger is separately designed for each model, when various models of products are charged together, it is difficult to distinguish between matching chargers, and batteries tend to be undercharged or overcharged, or even a charging accident may occur.

Therefore, how to provide a solution suitable for charging a variety of batteries has become a requirement in the related art.

### SUMMARY

The main objective of the present invention is to provide a charging apparatus, a charging system and a charging method, to resolve the technical problem that an existing charger is not applicable to a variety of batteries.

According to a first aspect, the present invention provides a charging apparatus. The charging apparatus is configured to charge a data communication battery, the data communication battery includes a plurality of batteries, and the charging apparatus includes a charging power supply and a balancing apparatus; the charging power supply is electrically connected to the data communication battery, the balancing apparatus is electrically connected to the data communication battery, and the balancing apparatus is configured to obtain first information of the data communication battery to implement voltage balancing among the batteries in the data communication battery according to the first information; and the charging power supply is configured to obtain second information of the data communication battery to output a voltage or current according to the second information to charge the data communication battery.

Preferably, the balancing apparatus is electrically connected to the charging power supply, and the charging power supply is configured to obtain the second information by using the balancing apparatus.

Preferably, the balancing apparatus includes a balancing processor and a balancing circuit electrically connected to the balancing processor, and the balancing processor is further electrically connected to the charging power supply and the data communication battery; the balancing circuit is further electrically connected to the batteries; the balancing processor is configured to obtain the first information and the second information of the data communication battery, and the balancing processor is configured to control the balancing circuit to implement the voltage balancing among the batteries according to the first information; and the balancing processor is further configured to transmit the second information to the charging power supply.

Preferably, the first information includes a temperature of the data communication battery, voltages of the batteries and a safety status of the batteries, the balancing processor is configured to calculate a voltage difference between the batteries, and when the temperature of the data communication battery is less than a first preset temperature, the safety status is a normal state, and the voltage difference is greater than a preset difference threshold, the balancing processor controls the balancing circuit to implement the voltage balancing among the batteries in the data communication battery.

Preferably, the balancing apparatus further includes a temperature sensor, the temperature sensor is electrically connected to the balancing processor, the temperature sensor is configured to obtain a temperature of the balancing apparatus, when the temperature of the balancing apparatus is greater than a second preset temperature, the balancing processor controls the balancing apparatus to stand by, and when the temperature of the data communication battery is greater than the first preset temperature or the safety status is an abnormal state, the balancing processor controls the balancing apparatus to stand by.

Preferably, the data communication battery includes a battery module and a battery processor electrically connected to the battery module; the battery module is further electrically connected to the balancing processor; and the battery processor is further electrically connected to the balancing processor, and the battery processor is configured to transmit the first information and the second information of the data communication battery to the balancing processor.

Preferably, the battery module further includes the plurality of batteries and a plurality of balancing ports, a quantity of the batteries is equal to a quantity of the balancing ports, each balancing port is electrically connected to one battery, the plurality of batteries are connected in series or in parallel, and the balancing circuit is electrically connected to the plurality of balancing ports.

Preferably, the charging power supply includes a power supply and a power supply processor electrically connected to the power supply, and both the power supply processor and the power supply are electrically connected to the data communication battery; and the power supply processor is configured to control the power supply to output a voltage or current according to the second information to charge the data communication battery.

Preferably, the second information includes a quantity of groups of the batteries, voltages of the batteries, a maximum charging current of the batteries, a safety status of the batteries and a temperature of the data communication battery; and when the temperature of the data communication battery is less than a first preset temperature and the safety status is a normal state, the power supply processor is configured to control the power supply to output the voltage or current according to the quantity of groups of the batteries, the voltages of the batteries and the maximum charging current of the batteries to charge the data communication battery.

Preferably, the power supply processor is further configured to control the charging power supply to stand by when the temperature of the data communication battery is greater than a first preset temperature or the safety status is an abnormal state.

According to a second aspect, the present invention further provides a charging system. The charging system includes a data communication battery and the charging apparatus according to the embodiment of the first aspect of the present application, and the data communication battery is electrically connected to the charging apparatus.

According to a third aspect, the present application further provides a charging method, which adopts the charging apparatus according to the embodiment of the first aspect of the present application to charge a data communication battery, where the data communication battery includes a plurality of batteries, and the charging method includes:

obtaining, by the balancing apparatus, the first information of the data communication battery;

implementing, by the balancing apparatus, the voltage balancing among the batteries in the data communication battery according to the first information;

obtaining, by the charging power supply, the second information of the data communication battery; and

outputting, by the charging power supply, a voltage or current according to the second information to charge the data communication battery.

Preferably, the first information includes voltages of the batteries, a safety status of the batteries and a temperature of the data communication battery, and the implementing, by the balancing apparatus, the voltage balancing among the batteries in the data communication battery according to the first information includes:

calculating, by the balancing apparatus, a voltage difference between the batteries; and

when the temperature of the data communication battery is less than a first preset temperature, the safety status is a normal state, and the voltage difference is greater than a preset difference threshold, implementing, by the balancing apparatus, the voltage balancing among the batteries in the data communication battery.

Preferably, the method includes:

obtaining, by the balancing apparatus, a temperature of the balancing apparatus;

when the temperature of the balancing apparatus is greater than a second preset temperature, making the balancing apparatus stand by; and

when the temperature of the data communication battery is greater than the first preset temperature or the safety status is an abnormal state, making the balancing apparatus stand by.

Preferably, the second information includes a quantity of groups of the batteries, voltages of the batteries, a maximum charging current of the batteries, a safety status of the batteries and a temperature of the data communication battery; and the outputting, by the charging power supply, a voltage or current according to the second information to charge the data communication battery comprises:

when the temperature of the data communication battery is less than a first preset temperature and the safety status is a normal state, outputting, by the charging power supply, the voltage or current according to the quantity of groups of the batteries, the voltages of the batteries and the maximum charging current of the batteries to charge the data communication battery.

Preferably, the charging method further includes:

when the temperature of the data communication battery is greater than the first preset temperature or the safety status is an abnormal state, making the charging power supply stand by.

Compared with the related art, the charging apparatus of the present invention includes a charging power supply and a balancing apparatus; the charging power supply is electrically connected to the data communication battery, the balancing apparatus is electrically connected to the data communication battery, and the balancing apparatus is configured to obtain first information of the data communication battery to implement voltage balancing among the batteries in the data communication battery according to the first information; the charging power supply is configured to obtain second information of the data communication battery; and the charging power supply outputs a voltage or current according to the second information to charge the data communication battery. The outputted voltage or current meets the requirements of the data communication battery, a charging speed is fast, and the balancing apparatus ensures the voltage balancing among the batteries in the data communication battery, thereby avoiding the problem of wire voltage drop. In this way, all the batteries of the data communication battery are more accurately balanced, so that the use of users can be greatly facilitated, and the advantages of intelligence, convenience and high precision are obtained. The balancing apparatus is not integrated with the data communication battery, that is, the balancing apparatus is externally disposed, so that a lot of circuit space of the data communication battery can be saved, making it more suitable for applications such as unmanned aerial vehicles that have relatively high space and weight requirements.

Compared with the related art, in the charging method of the present invention, the balancing apparatus obtains first information of the data communication battery; the balancing apparatus implements voltage balancing among the batteries in the data communication battery according to the first information; the charging power supply obtains second information of the data communication battery; and the charging power supply outputs a voltage or current according to the second information to charge the data communication battery. The outputted voltage or current meets the requirements of the data communication battery, a charging speed is fast, and the balancing apparatus ensures the voltage balancing among the batteries in the data communication battery, thereby avoiding the problem of wire voltage drop. In this way, all the batteries of the data communication battery are more accurately balanced, so that the use of users can be greatly facilitated, and the advantages of intelligence, convenience and high precision are obtained.

### BRIEF DESCRIPTION OF THE DRAWINGS

FIG. 1 is a schematic diagram of a modular structure in which a charging apparatus is electrically connected to a data communication battery according to the present invention.

FIG. 2 is a more detailed schematic diagram of a modular structure in which a charging apparatus is electrically connected to a data communication battery according to the present invention.

FIG. 3 is a schematic diagram of a modular structure of another embodiment in which a charging apparatus is electrically connected to a data communication battery according to the present invention.

FIG. 4 is a schematic diagram of a modular structure of a charging system according to the present invention.

FIG. 5 is a schematic flowchart of a charging method according to the present invention.

FIG. 6 is a detailed schematic flowchart of step S12 in FIG. 5.

### DETAILED DESCRIPTION

To make the objectives, technical solutions, and advantages of the present invention clearer and more comprehensible, the following further describes the present invention in detail with reference to the accompanying drawings and embodiments. It should be understood that the embodiments herein are provided for describing the present invention and not intended to limit the present invention. All other embodiments obtained by a person of ordinary skill in the art based on the embodiments of the present invention without creative efforts shall fall within the protection scope of the present invention.

The terms such as “first”, “second”, “third”, and “fourth” (if any) in the specification and claims of the present application and in the accompanying drawings are used for distinguishing between similar objects and not necessarily used for describing any particular order or sequence. It is to be understood that the data used in such a way is interchangeable in proper cases, so that the embodiments described herein can be implemented in other orders than the order illustrated or described herein. Moreover, the terms “include”, “contain” and any other variants mean to cover the non-exclusive inclusion. For example, a process, method, system, product, or device that includes a list of steps or units is not necessarily limited to those steps or units, but may include other steps or units not expressly listed or inherent to such a process, method, product, or device.

In addition, technical solutions between the embodiments may be combined with each other, provided that the combination of the technical solutions can be implemented by a person of ordinary skill in the art. When the combined technical solutions conflict with each other or cannot be implemented, it should be considered that such a combination of the technical solutions does not exist or is not within the protection scope of the present invention.

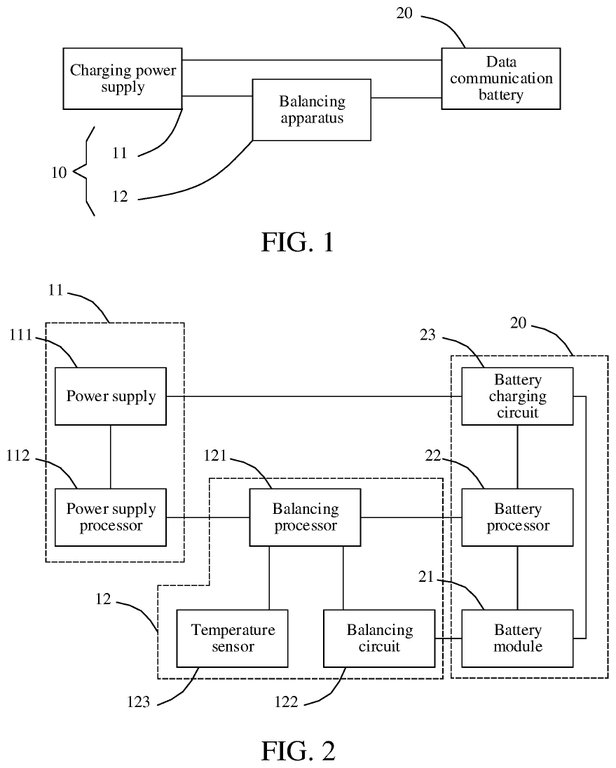

Referring to both FIG. 1 and FIG. 2, the present invention provides a charging apparatus 10. The charging apparatus 10 is configured to charge a data communication battery 20. The charging apparatus 10 includes a charging power supply 11 and a balancing apparatus 12 electrically connected to the charging power supply 11. The charging power supply 11 and the balancing apparatus 12 are electrically connected to the data communication battery 20. The charging power supply 11 is electrically connected to the data communication battery 20. The balancing apparatus 12 is electrically connected to the data communication battery 20. In this embodiment, the charging power supply 11 is electrically connected to the data communication battery 20 by the balancing apparatus 12. The balancing apparatus 12 is configured to obtain first information of the data communication battery 20 to implement the voltage balancing among the batteries in the data communication battery 20 according to the first information. The charging power supply 11 is configured to obtain second information of the data communication battery 20. The charging power supply 11 outputs a voltage or current according to the second information to charge the data communication battery 20. Preferably, the charging power supply 11 is electrically connected to the data communication battery 20, the balancing apparatus 12 is electrically connected to the data communication battery 20, and the charging power supply 11 is electrically connected to the balancing apparatus 12, detachable connections, for example, a plug manner and an interface manner, may be adopted, and specifically, by a Universal Serial Bus (USB) interface and a USB plug. The balancing apparatus 12 is not integrated with the data communication battery 20, that is, the balancing apparatus 12 is externally disposed relative to the data communication battery 20, so that a lot of wiring space of the data communication battery 20 can be saved. The first information includes voltages of the batteries, a safety status of the batteries and a temperature of the data communication battery 20. The second information includes a quantity of groups of the batteries, voltages of the batteries, a maximum charging current of the batteries, a safety status of the batteries and a temperature of the data communication battery. The first information and the second information may overlap.

The data communication battery 20 includes a battery module 21, a battery processor 22 and a battery charging circuit 23. The battery module 21 is electrically connected to the battery processor 22 to supply power to the battery processor 22. The battery processor 22 is further electrically connected to the battery charging circuit 23. The battery charging circuit 23 is electrically connected to the battery module 21 and the charging power supply 11. The battery processor 22 can obtain information of the data communication battery 20 and transmit the obtained information of the data communication battery 20 to the balancing apparatus 12. The charging power supply 11 charges the battery module 21 through the battery charging circuit 23. It may be understood that the battery charging circuit 23 may be omitted. The charging power supply 11 may directly charge the battery module 21. When the battery processor 22 is electrically connected to the charging power supply 11 and the balancing apparatus 12, detachable connections are adopted. The information of the data communication battery 20 includes the first information and the second information.

The battery module 21 includes the plurality of batteries and a plurality of balancing ports. A quantity of the batteries is equal to a quantity of the balancing ports. Each balancing port is electrically connected to one battery. The balancing circuit is electrically connected to the plurality of balancing ports. The balancing apparatus 12 can implement the voltage balancing among the batteries in the data communication battery 20 through the balancing port, that is, to make voltages among the plurality of batteries in the data communication battery 20 tend to be equal.

The batteries are rechargeable batteries. The plurality of batteries are connected in series or in parallel. The plurality of batteries can form a plurality of batteries or battery packs. It may be understood that the batteries may be cells.

The battery processor 22 includes a control chip. A specific model of the control chip is not limited. The information of the batteries of the battery module 21 obtained by the battery processor 22 includes, but is not limited to, a temperature of the data communication battery 20, voltages of the batteries, a maximum charging current of the batteries, a safety status of the batteries and a quantity of groups of the batteries. The safety status includes a normal state and an abnormal state. The abnormal state includes a short circuit, an overvoltage, and an undervoltage. Preferably, when the safety status of the batteries is the abnormal state, the battery processor 22 raises an alarm.

The battery charging circuit 23 is a charging circuit. A specific circuit structure of the battery charging circuit 23 is no longer limited.

The balancing apparatus 12 includes a balancing processor 121, a balancing circuit 122 and a temperature sensor 123. The balancing processor 121 is electrically connected to the balancing circuit 122 and the temperature sensor 123. The balancing circuit 122 is further electrically connected to the balancing port of the data communication battery 20 to implement the voltage balancing among the batteries in the data communication battery 20. The balancing processor 121 is further electrically connected to the charging power supply 11.

The temperature sensor 123 is configured to obtain the temperature of the balancing apparatus 12. A specific model of the temperature sensor 123 is not limited provided that the temperature generated by the balancing apparatus 12 in a working process can be sensed.

The balancing processor 121 includes a control chip. A specific model of the control chip is not limited. The balancing processor 121 is configured to obtain the first information and the second information of the data communication battery 20. The balancing processor 121 is configured to control the balancing circuit 122 to implement the voltage balancing among the batteries according to the first information. The balancing processor 121 is further configured to transmit the second information to the charging power supply.

Specifically, the balancing processor 121 obtains the first information and the second information through the battery processor 22. The balancing processor 121 is configured to calculate a voltage difference between the batteries. When the temperature of the data communication battery 20 is less than a first preset temperature, the safety status is a normal state, and the voltage difference is greater than a preset difference threshold, the balancing processor 121 controls the balancing circuit 122 to implement the voltage balancing among the batteries in the data communication battery 20. A specific value of the first preset temperature is not limited, and may be set as required. The first preset temperature is less than or equal to the highest temperature at which balancing among the batteries can be implemented. A difference threshold is a maximum difference that is allowed between the batteries. When the temperature of the data communication battery 20 is greater than the first preset temperature or the safety status is an abnormal state, the balancing processor 121 controls the balancing apparatus 12 to stand by. When the temperature of the balancing apparatus 12 is greater than a second preset temperature, the balancing processor 121 is configured to control the balancing apparatus 12 to stand by. It should be noted that, in the present application, the balancing among the batteries of the data communication battery 20 is a process of discharging a battery with a high voltage in the batteries connected in series in the data communication battery 20. The balancing is passive balancing rather than overcharging a battery with a low voltage. For example, the data communication battery 20 includes a battery A and a battery B that are connected in series. When a voltage of the battery A is greater than a voltage of the battery B, and a voltage difference between the battery A and the battery B is greater than a difference threshold, the battery A is discharged during balancing.

The charging power supply 11 obtains the second information through the balancing processor 121 of the balancing apparatus 12. The charging power supply 11 includes a power supply 111 and a power supply processor 112 electrically connected to the power supply 111. The power supply processor 112 is further electrically connected to the balancing processor 121 of the balancing apparatus 12. The power supply 111 is further electrically connected to the battery charging circuit 23 of the data communication battery 20. The power supply processor 112 of the charging power supply 11 obtains the second information through the balancing processor 121 of the balancing apparatus 12.

The power supply processor 112 includes a control chip. A specific model of the control chip is not limited. After the power supply processor 112 receives the second information sent by the balancing processor 121, the power supply processor 112 is configured to control the power supply 111 to output a voltage or current according to the second information to charge the data communication battery 20. Specifically, the power supply processor 112 is configured to control the power supply 111 to output the voltage or current according to the quantity of groups of the batteries, the voltages of the batteries and the maximum charging current of the batteries to charge the data communication battery 20. The power supply processor 20 is further configured to control the charging power supply 11 to stand by when the temperature of the data communication battery 20 is greater than a first preset temperature or the safety status is an abnormal state, and the power supply 111 stops charging the data communication battery 20.

The power supply 111 may convert utility power into required alternating current or direct current. A specific model of the power supply 111 is not limited, and may be selected as required.

During use, the balancing processor 121 obtains the temperature of the data communication battery 20, the voltage of the battery, the maximum charging current of the batteries, the safety status of the batteries and the quantity of groups of the batteries through the battery processor 22. When the temperature of the data communication battery 20 is greater than the first preset temperature, the balancing processor controls the balancing apparatus to stand by, and the power supply processor controls the charging power supply to stand by. When the safety status is an abnormal state, the balancing processor controls the balancing apparatus to stand by, and the power supply processor controls the charging power supply to stand by. The balancing processor further calculates a voltage difference between the batteries. When the temperature of the data communication battery is less than a first preset temperature, the safety status is a normal state, and the voltage difference is greater than a preset difference threshold, the balancing processor controls the balancing circuit to implement the voltage balancing among the batteries in the data communication battery. When the temperature of the data communication battery is less than a first preset temperature and the safety status is a normal state, the power supply processor is configured to control the power supply to output the voltage or current according to the quantity of groups of the batteries, the voltages of the batteries and the maximum charging current of the batteries to charge the data communication battery.

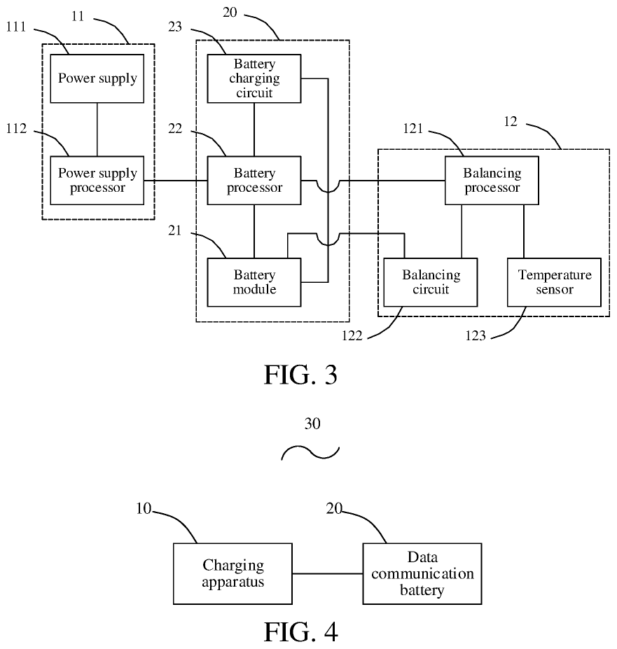

Referring to FIG. 3, it may be understood that the power supply processor 112 of the charging power supply 11 may not be electrically connected to the balancing processor 121 of the balancing apparatus 12, and the power supply processor 112 of the charging power supply 11 may be directly electrically connected to the battery processor 22 of the data communication battery 20 to directly obtain the information of the data communication battery 20. That is, the charging power supply 11 and the balancing apparatus 12 are electrically connected to the data communication battery 20. The charging power supply 11 and the balancing apparatus 12 independently work. That is, the charging of the data communication battery 20 by the charging power supply 11 and the balancing of the data communication battery 20 by the balancing apparatus 12 may be independently performed.

Referring to FIG. 4, the present invention further provides a charging system 30. The charging system 30 includes the data communication battery 20 and the charging apparatus 10. The data communication battery 20 is electrically connected to the charging apparatus 10. The charging apparatus 10 is configured to charge the data communication battery 20.

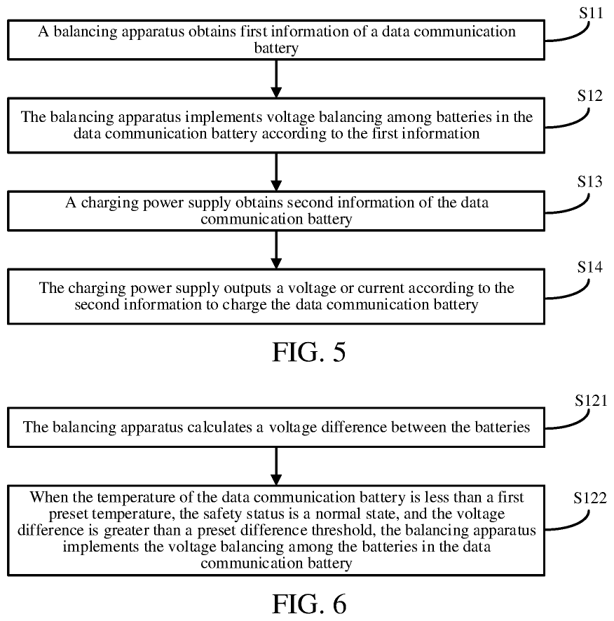

Referring to FIG. 5, the present invention further provides a charging method, which adopts the charging apparatus to charge a data communication battery. The data communication battery includes a plurality of batteries. The charging method includes the following steps:

S11. A balancing apparatus obtains first information of a data communication battery.

The first information includes voltages of the batteries, a safety status of the batteries and a temperature of the data communication battery.

S12. The balancing apparatus implements voltage balancing among the batteries in the data communication battery according to the first information.

Referring to FIG. 6, specifically, step S12 includes the following steps.

S121. The balancing apparatus calculates a voltage difference between the batteries.

S122. When the temperature of the data communication battery is less than a first preset temperature, the safety status is a normal state, and the voltage difference is greater than a preset difference threshold, the balancing apparatus implements the voltage balancing among the batteries in the data communication battery.

Preferably, before the balancing apparatus implements voltage balancing among the batteries in the data communication battery according to the first information, the method further includes the following steps:

determining whether the safety status is a normal state, and determining that the temperature of the data communication battery is less than a first preset temperature; and

when the temperature of the data communication battery is greater than the first preset temperature or the safety status is an abnormal state, making the balancing apparatus stand by.

S13. A charging power supply obtains second information of the data communication battery.

The second information includes a quantity of groups of the batteries, voltages of the batteries, a maximum charging current of the batteries, a safety status of the batteries and a temperature of the data communication battery.

S14. The charging power supply outputs a voltage or current according to the second information to charge the data communication battery.

Specifically, when the temperature of the data communication battery is less than a first preset temperature and the safety status is a normal state, outputting, by the charging power supply, the voltage or current according to the quantity of groups of the batteries, the voltages of the batteries and the maximum charging current of the batteries to charge the data communication battery.

Preferably, before the balancing apparatus implements voltage balancing among the batteries in the data communication battery according to the first information, the method further includes the following steps:

determining whether the safety status is a normal state, and determining that the temperature of the data communication battery is less than a first preset temperature; and

when the temperature of the data communication battery is greater than the first preset temperature or the safety status is an abnormal state, making the charging power supply stand by.

Preferably, the charging method further includes the following step: obtaining, by the balancing apparatus, a temperature of the balancing apparatus; and when the temperature of the balancing apparatus is greater than a second preset temperature, making the balancing apparatus stand by.

Compared with the related art, the charging apparatus of the present invention includes a charging power supply and a balancing apparatus; the charging power supply is electrically connected to the data communication battery, the balancing apparatus is electrically connected to the data communication battery, and the balancing apparatus is configured to obtain first information of the data communication battery to implement voltage balancing among the batteries in the data communication battery according to the first information; and the charging power supply is configured to obtain second information of the data communication battery; and the charging power supply outputs a voltage or current according to the second information to charge the data communication battery. The outputted voltage or current meets the requirements of the data communication battery, a charging speed is fast, and the balancing apparatus ensures the voltage balancing among the batteries in the data communication battery, thereby avoiding the problem of wire voltage drop. In this way, all the batteries of the data communication battery are more accurately balanced, so that the use of users can be greatly facilitated, and the advantages of intelligence, convenience and high precision are obtained. The balancing apparatus is not integrated with the data communication battery, that is, the balancing apparatus is externally disposed, so that a lot of circuit space of the data communication battery can be saved, making it more suitable for applications such as unmanned aerial vehicles that have relatively high space and weight requirements.

Compared with the related art, in the charging method of the present invention, the balancing apparatus obtains first information of the data communication battery; the balancing apparatus implements voltage balancing among the batteries in the data communication battery according to the first information; the charging power supply obtains second information of the data communication battery; and the charging power supply outputs a voltage or current according to the second information to charge the data communication battery. The outputted voltage or current meets the requirements of the data communication battery, a charging speed is fast, and the balancing apparatus ensures the voltage balancing among the batteries in the data communication battery, thereby avoiding the problem of wire voltage drop. In this way, all the batteries of the data communication battery are more accurately balanced, so that the use of users can be greatly facilitated, and the advantages of intelligence, convenience and high precision are obtained.

It should be noted that the sequence numbers of the foregoing embodiments of the present invention are merely for description purpose but do not represent the preference of the embodiments. In addition, the terms “include”, “comprise”, or any other variation thereof in this specification is intended to cover a non-exclusive inclusion, which specifies the presence of stated processes, apparatuses, objects, or methods, but do not preclude the presence or addition of one or more other processes, apparatuses, objects, or methods. Without more limitations, elements defined by the sentence “including one” does not exclude that there are still other same elements in the processes, apparatuses, objects, or methods.

The foregoing descriptions are preferred embodiments of the present invention, and the protection scope of the present invention is not limited thereto. All equivalent structure or process changes made according to the content of this specification and accompanying drawings in the present invention or by directly or indirectly applying the present invention in other related technical fields shall fall within the protection scope of the present invention.

What is claimed is:

1. A charging apparatus, wherein the charging apparatus is configured to charge a data communication battery, the data communication battery comprises a plurality of batteries, and the charging apparatus comprises a charging power supply and a balancing apparatus; the charging power supply is electrically connected to the data communication battery, the balancing apparatus is electrically connected to the data communication battery, and the balancing apparatus is configured to obtain first information of the data communication battery to implement voltage balancing among the batteries in the data communication battery according to the first information; and the charging power supply is configured to obtain second information of the data communication battery to output a voltage or current according to the second information to charge the data communication battery.

2. The charging apparatus according to claim 1, wherein the balancing apparatus is electrically connected to the charging power supply, and the charging power supply is configured to obtain the second information by using the balancing apparatus.

3. The charging apparatus according to claim 2, wherein the balancing apparatus comprises a balancing processor and a balancing circuit electrically connected to the balancing processor, and the balancing processor is further electrically connected to the charging power supply and the data communication battery; the balancing circuit is further electrically connected to the batteries; the balancing processor is configured to obtain the first information and the second information of the data communication battery, and the balancing processor is configured to control the balancing circuit to implement the voltage balancing among the batteries according to the first information; and the balancing processor is further configured to transmit the second information to the charging power supply.

4. The charging apparatus according to claim 3, wherein the first information comprises a temperature of the data communication battery, voltages of the batteries and a safety status of the batteries, the balancing processor is configured to calculate a voltage difference between the batteries, and when the temperature of the data communication battery is less than a first preset temperature, the safety status is a normal state, and the voltage difference is greater than a preset difference threshold, the balancing processor controls the balancing circuit to implement the voltage balancing among the batteries in the data communication battery.

5. The charging apparatus according to claim 3, wherein the balancing apparatus further comprises a temperature sensor, the temperature sensor is electrically connected to the balancing processor, the temperature sensor is configured to obtain a temperature of the balancing apparatus, when the temperature of the balancing apparatus is greater than a second preset temperature, the balancing processor controls the balancing apparatus to stand by, and when a temperature of the data communication battery is greater than a first preset temperature or a safety status is an abnormal state, the balancing processor controls the balancing apparatus to stand by.

6. The charging apparatus according to claim 3, wherein the data communication battery comprises a battery module and a battery processor electrically connected to the battery module; the battery module is further electrically connected to the balancing processor; and the battery processor is further electrically connected to the balancing processor, and the battery processor is configured to transmit the first information and the second information of the data communication battery to the balancing processor.

7. The charging apparatus according to claim 6, wherein the battery module further comprises the plurality of batteries and a plurality of balancing ports, a quantity of the batteries is equal to a quantity of the balancing ports, each balancing port is electrically connected to one battery, the plurality of batteries are connected in series or in parallel, and the balancing circuit is electrically connected to the plurality of balancing ports.

8. The charging apparatus according to claim 1, wherein the charging power supply comprises a power supply and a power supply processor electrically connected to the power supply, and both the power supply processor and the power supply are electrically connected to the data communication battery; and the power supply processor is configured to control the power supply to output a voltage or current according to the second information to charge the data communication battery.

9. The charging apparatus according to claim 8, wherein the second information comprises a quantity of groups of the batteries, voltages of the batteries, a maximum charging current of the batteries, a safety status of the batteries and a temperature of the data communication battery; and when the temperature of the data communication battery is less than a first preset temperature and the safety status is a normal state, the power supply processor is configured to control the power supply to output the voltage or current according to the quantity of groups of the batteries, the voltages of the batteries and the maximum charging current of the batteries to charge the data communication battery.

10. The charging apparatus according to claim 9, wherein the power supply processor is further configured to control the charging power supply to stand by when the temperature of the data communication battery is greater than the first preset temperature or the safety status is an abnormal state.

11. A charging system, wherein the charging system comprises a data communication battery and a charging apparatus and the data communication battery is electrically connected to the charging apparatus, wherein the charging apparatus is configured to charge a data communication battery, the data communication battery comprises a plurality of batteries, and the charging apparatus comprises a charging power supply and a balancing apparatus; the charging power supply is electrically connected to the data communication battery, the balancing apparatus is electrically connected to the data communication battery, and the balancing apparatus is configured to obtain first information of the data communication battery to implement voltage balancing among the batteries in the data communication battery according to the first information; and the charging power supply is configured to obtain second information of the data communication battery to output a voltage or current according to the second information to charge the data communication battery.

12. The charging system according to claim 11, wherein the balancing apparatus is electrically connected to the charging power supply, and the charging power supply is configured to obtain the second information by using the balancing apparatus.

13. The charging system according to claim 12, wherein the balancing apparatus comprises a balancing processor and a balancing circuit electrically connected to the balancing processor, and the balancing processor is further electrically connected to the charging power supply and the data communication battery; the balancing circuit is further electrically connected to the batteries; the balancing processor is configured to obtain the first information and the second information of the data communication battery, and the balancing processor is configured to control the balancing circuit to implement the voltage balancing among the batteries according to the first information; and the balancing processor is further configured to transmit the second information to the charging power supply.

14. The charging system according to claim 13, wherein the first information comprises a temperature of the data communication battery, voltages of the batteries and a safety status of the batteries, the balancing processor is configured to calculate a voltage difference between the batteries, and when the temperature of the data communication battery is less than a first preset temperature, the safety status is a normal state, and the voltage difference is greater than a preset difference threshold, the balancing processor controls the balancing circuit to implement the voltage balancing among the batteries in the data communication battery.

15. The charging system according to claim 13, wherein the balancing apparatus further comprises a temperature sensor, the temperature sensor is electrically connected to the balancing processor, the temperature sensor is configured to obtain a temperature of the balancing apparatus, when the temperature of the balancing apparatus is greater than a second preset temperature, the balancing processor controls the balancing apparatus to stand by, and when a temperature of the data communication battery is greater than a first preset temperature or a safety status is an abnormal state, the balancing processor controls the balancing apparatus to stand by.

16. The charging system according to claim 13, wherein the data communication battery comprises a battery module and a battery processor electrically connected to the battery module; the battery module is further electrically connected to the balancing processor; and the battery processor is further electrically connected to the balancing processor, and the battery processor is configured to transmit the first information and the second information of the data communication battery to the balancing processor.

17. The charging system according to claim 16, wherein the battery module further comprises the plurality of batteries and a plurality of balancing ports, a quantity of the batteries is equal to a quantity of the balancing ports, each balancing port is electrically connected to one battery, the plurality of batteries are connected in series or in parallel, and the balancing circuit is electrically connected to the plurality of balancing ports.

18. The charging system according to claim 11, wherein the charging power supply comprises a power supply and a power supply processor electrically connected to the power supply, and both the power supply processor and the power supply are electrically connected to the data communication battery; and the power supply processor is configured to control the power supply to output a voltage or current according to the second information to charge the data communication battery.

19. The charging system according to claim 18, wherein the second information comprises a quantity of groups of the batteries, voltages of the batteries, a maximum charging current of the batteries, a safety status of the batteries and a temperature of the data communication battery; and when the temperature of the data communication battery is less than a first preset temperature and the safety status is a normal state, the power supply processor is configured to control the power supply to output the voltage or current according to the quantity of groups of the batteries, the voltages of the batteries and the maximum charging current of the batteries to charge the data communication battery.

20. A charging method, applicable to a charging apparatus, wherein the charging apparatus is configured to charge a data communication battery, the data communication battery comprises a plurality of batteries, and the charging apparatus comprises a charging power supply and a balancing apparatus; the charging power supply is electrically connected to the data communication battery, the balancing apparatus is electrically connected to the data communication battery, and the balancing apparatus is configured to obtain first information of the data communication battery to implement voltage balancing among the batteries in the data communication battery according to the first information; the charging power supply is configured to obtain second information of the data communication battery to output a voltage or current according to the second information to charge the data communication battery; and
the charging method comprises:
obtaining, by the balancing apparatus, the first information of the data communication battery;
implementing, by the balancing apparatus, the voltage balancing among the batteries in the data communication battery according to the first information;
obtaining, by the charging power supply, the second information of the data communication battery; and
outputting, by the charging power supply, a voltage or current according to the second information to charge the data communication battery.

21. The charging apparatus according to claim 20, wherein the first information comprises voltages of the batteries, a safety status of the batteries and a temperature of the data communication battery, and the implementing, by the balancing apparatus, the voltage balancing among the batteries in the data communication battery according to the first information comprises:
calculating, by the balancing apparatus, a voltage difference between the batteries; and
when the temperature of the data communication battery is less than a first preset temperature, the safety status is a normal state, and the voltage difference is greater than a preset difference threshold, implementing, by the balancing apparatus, the voltage balancing among the batteries in the data communication battery.

22. The charging apparatus according to claim 21, wherein the charging method further comprises:
obtaining, by the balancing apparatus, a temperature of the balancing apparatus;
when the temperature of the balancing apparatus is greater than a second preset temperature, making the balancing apparatus stand by; and
when the temperature of the data communication battery is greater than the first preset temperature or the safety status is an abnormal state, making the balancing apparatus stand by.

23. The charging apparatus according to claim 20, wherein the second information comprises a quantity of groups of the batteries, voltages of the batteries, a maximum charging current of the batteries, a safety status of the batteries and a temperature of the data communication battery; and the outputting, by the charging power supply, a voltage or current according to the second information to charge the data communication battery comprises:
when the temperature of the data communication battery is less than a first preset temperature and the safety status is a normal state, outputting, by the charging power supply, the voltage or current according to the quantity of groups of the batteries, the voltages of the batteries and the maximum charging current of the batteries to charge the data communication battery.

24. The charging method according to claim 23, wherein the charging method further comprises:
when the temperature of the data communication battery is greater than the first preset temperature or the safety status is an abnormal state, making the charging power supply stand by.
